(19) United States
(12) Patent Application Publication
(10) Pub. No.: US 2003/0066547 A1
(43) Pub. Date: Apr. 10, 2003

(54) Fiber stripper system

(76) Inventors: Patrick J. Burke, Corning, NY (US); William J. Miller, Horseheads, NY (US); Mark L. Morrell, Horseheads, NY (US)

Correspondence Address: CORNING INCORPORATED, SP-TI-3-1, CORNING, NY, 14831

(21) Appl. No.: 09/974,517

(22) Filed: Oct. 9, 2001

(51) Int. Cl. B08B 7/04; B29D 11/00; B05D 1/40

(52) U.S. Cl. 134/21; 216/24; 427/345

(57) ABSTRACT

A fiber coating stripping apparatus and method for removing an outer coating of an optical fiber including a fiber stripper with a nozzle adapted to spray a stripping medium toward an outer surface of the optical fiber to remove the outer coating, a stripper exhaust including a liquid injection mechanism that provides a liquid to an interior of the stripper exhaust, and a vacuum generator fluidically connected to the stripper exhaust that creates an airflow through the exhaust opening to vacuum the removed outer coating of the optical fiber and to vacuum the liquid provided by the liquid injection mechanism. The liquid is a coolant that cools the removed outer coating and rinses the interior of the stripper exhaust. In one embodiment, the liquid is provided by the liquid injection mechanism with a distribution ring having a plurality of spray openings.

### BACKGROUND OF THE INVENTION

1. Field of the Invention

The present invention is directed to fiber stripper system and method for removing the outer covering of an optical fiber. In particular, the present invention is directed to such a fiber stripper system with reduced maintenance requirements.

2. Technical Background

Glass optical fibers have very small diameters and are susceptible to external influences such as mechanical stress and environmental conditions. To protect the fiber from such influences, it is provided with one or more coatings of a protective material.

Certain applications, such as, for example optical coupler manufacturing and fabrication of fiber gratings require that a portion of the protective outer coating to be removed from an end of the fiber or to be removed from a portion of the fiber which is remote from the ends. It is important that the stripped portions of the fibers do not become weakened during the stripping process since weakened fibers can fail during subsequent process steps or during handling of the coupler when tensile stress is applied to the pigtails. Thus, the apparatus and method used to strip the coating of the optical fiber should not inordinately reduce fiber strength.

In view of the above, an improved method for removing the protective outer coating from an optical fiber has been proposed in U.S. Pat. No. 5,948,202 and No. 6,123,801 both to Miller and such a method is implemented in U.S. Pat. No. 6,092,294 to Backer et al. In these references, the coating is removed from the optical fiber by providing a nozzle that directs a heated inert gas such as, for example nitrogen, argon, helium, carbon dioxide and mixtures thereof onto the outer surface of the fiber. As the hot inert gas softens the outer coating, small particles of the outer coating are blown off the optical fiber thereby stripping that portion of the optical fiber. Parameters of the inert gas such as gas temperature and gas flow rate are used corresponding to the softening characteristics of the particular coating material to effectively remove the coating without inordinate damage to the optical fiber. In this regard, both of the Miller references also disclose that as the small particles of protective outer coating are blown from the optical fiber, it is desirable to provide an exhaust vent for allowing the exhaust of heated inert gas. However, in using the apparatus and method for removing protective outer coating from an optical fiber in accordance with the teachings of the prior art, various limitations and disadvantages has been uncovered as described below.

### SUMMARY OF THE INVENTION

In particular, the present inventors have found that a significant amount of maintenance is required to use the apparatus and method for removing protective outer coating from an optical fiber in accordance with the teachings of the prior art which results in downtime that undermines productivity. In particular, although the prior art teaches the provision of an exhaust vent, the present inventors have found that the melted small particles of protective coating entered the exhaust vent, impinged on the walls of the exhaust vent, and solidified along the walls as the particles slowly cooled. Within a relatively short period of operation, the exhaust vent became covered with the removed protective coating requiring the apparatus to be shut down and cleaned.

In addition, when the exhaust vent was improved to include a vacuum generator to facilitate the removal of the small particles from the optical fiber being stripped, the small particles tended to clog the vacuum generator when they were not sufficiently cooled due to their adhesion properties when in a melted state. Of course, such clogging of the vacuum generator requires the apparatus to be again shut down for maintenance and cleaning thereby further undermining productivity.

In view of the foregoing, the present invention has the advantage of providing an improved fiber coating stripping apparatus and method for removing an outer coating of an optical fiber with reduced maintenance requirements.

Another advantage of the present invention is in providing such a fiber coating stripping apparatus and method having a liquid injection mechanism that aids in maintaining various components of the fiber coating stripping apparatus clean.

Still another advantage of a preferred embodiment of the present invention is in providing such a fiber coating stripping apparatus and method having a liquid injection mechanism that will aid in cooling the removed outer coating of the optical fiber for disposal.

Yet another advantage of a preferred embodiment is in providing such a fiber coating stripping apparatus and method that will minimize the clogging of a vacuum generator.

These advantages and others are obtained by a fiber coating stripping apparatus for removing the protective coating of an optical fiber in accordance with one preferred embodiment of the present invention including a nozzle adapted to spray a stripping medium toward the optical fiber to remove the outer coating provided on the optical fiber, a stripper exhaust with an exhaust opening positioned proximate to the nozzle such that the optical fiber is positioned substantially between the fiber stripper and the exhaust opening, the stripper exhaust including a liquid injection mechanism that provides a liquid to an interior of the stripper exhaust, and a vacuum generator fluidically connected to the stripper exhaust that creates an airflow through the exhaust opening to vacuum the removed outer coating of the optical fiber and to vacuum the liquid provided by the liquid injection mechanism.

In accordance with one embodiment of the present invention, the liquid is a coolant that cools the removed protective coating of the optical fiber as the removed protective coating is vacuumed by the vacuum generator. In another embodiment, the liquid is provided to the interior wall of the stripper exhaust so that the liquid rinses the interior of the stripper exhaust as the liquid flows along the interior wall. In this regard, the liquid provided by the liquid injection mechanism is water in one embodiment. The liquid injection mechanism of one embodiment includes a plurality of spray openings positioned along an interior wall of the stripper exhaust. In another preferred embodiment, the liquid injection mechanism includes a distribution ring to distribute the liquid. The distribution ring preferably includes a plurality of spray openings for providing the liquid to the interior of the stripper exhaust. The liquid is preferably used to cool the removed outer coating of the optical fiber and to rinse the interior wall of the stripper exhaust.

In other embodiments of the present invention, the vacuum generator includes a venturi and a plurality of jets for providing compressed air to the venturi to generate vacuum and to further cool the removed protective covering. In another embodiment, a holding tank is provided to receive the protective coating of the optical fiber removed by the fiber stripper and vacuumed though the stripper exhaust.

In accordance with another aspect of the present invention, a method of stripping the protective coating of an optical fiber is provided having the steps of providing a fiber stripper with a nozzle, spraying a stripping medium from the nozzle toward the optical fiber to remove the protective coating, vacuuming the removed protective coating and injecting a liquid to cool the removed outer coating as the removed protective coating is vacuumed.

In another embodiment of the present method, the step of vacuuming the removed outer coating is attained by generating a suction airflow through a stripper exhaust. In another embodiment, the liquid is injected onto an interior wall of the stripper exhaust in one embodiment and the method further including the step of rinsing the interior wall of the stripper exhaust with the injected liquid.

In accordance with still another embodiment of the present method, the step of injecting the liquid is attained by a liquid injection mechanism. In this regard, in one embodiment, the liquid injection mechanism includes a plurality of spray openings positioned along the interior wall of the stripper exhaust. In accordance with another embodiment, the liquid injection mechanism includes a distribution ring to distribute the liquid. In the above regard, the liquid is water in one embodiment of the present method.

In accordance with yet another embodiment, the present method further includes the step of adding compressed air to generate the vacuum and to add additional air to further cool the removed outer coating. In still another embodiment, the present method further includes the step of collecting the removed outer coating of the optical fiber removed by the fiber stripper and vacuumed by the stripper exhaust.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic view of the improved fiber coating stripping apparatus 10 in accordance with one embodiment of the present invention.

FIG. 2 is an enlarged perspective view of the exhaust opening of the stripper exhaust in accordance with one embodiment of the present invention.

FIGS. 3A and 3B are disassembled cross-sectional views of the components of the stripper exhaust of FIG. 2.

FIG. 3C is an enlarged cross-sectional view of the spray opening indicated as “A” in FIG. 3B.

FIG. 4 is a cross-sectional view of the vacuum generator of the fiber coating stripping apparatus in accordance with one embodiment of the present invention.

FIG. 5 is a flow diagram illustrating a method of stripping an outer coating of an optical fiber in accordance with one embodiment of the present invention.

### DETAILED DESCRIPTION OF THE PREFERRED EMBODIMENT

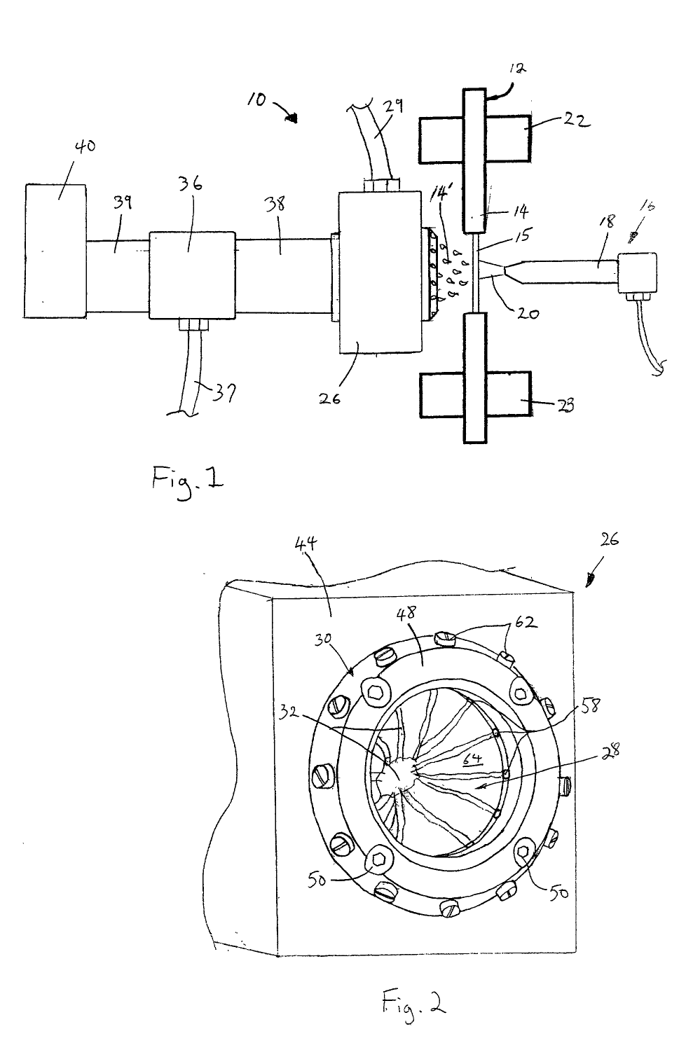

FIG. 1 illustrates an improved fiber coating stripping apparatus 10 for removing an outer coating of an optical fiber in accordance with one embodiment of the present invention. As will be evident from the discussion below, the stripping apparatus 10 allows efficient removal of the outer coating of the optical fiber with reduced maintenance requirements. In this regard, as discussed in further detail below, the stripping apparatus 10 includes provisions for clean operation and for cooling the removed outer coating of the optical fiber for disposal. In addition, it should also be evident how the present invention can be used to minimize clogging of a vacuum generator.

As can be clearly seen in FIG. 1, the fiber coating stripping apparatus 10 in accordance with the illustrated embodiment of the present invention is used to remove a protective coating 14 of an optical fiber 12 to expose the outermost glass cladding 15 of the optical fiber 12. It should initially be noted that the optical fiber 12 and its relative proportions have been enlarged in FIG. 1 as compared to the various components of the stripping apparatus 10 to more clearly illustrate the outer coating 14 and the removal thereof. In the illustrated embodiment, the fiber coating stripping apparatus 10 includes a fiber stripper 16 with a nozzle 18 adapted to spray a stripping medium 20 toward the optical fiber 12 to remove the protective coating 14 provided on the optical fiber 12. In this regard, the optical fiber 12 is held by retaining mechanisms 22 and 23 to allow the spraying of the stripping medium 20 onto the optical fiber 12. The protective coating 14 of the illustrated embodiment is a protective polymer coating that is present in most optical fibers used in the art. The hot stripping medium 20 softens or melts the protective coating 14 and blows it off the optical fiber thereby exposing the outermost glass cladding 15. In addition, in the illustrated embodiment, the stripping medium 20 which is sprayed by the nozzle 18 to strip the outer coating 14 is hot, pressurized nitrogen. However, it should be appreciated that in other embodiments, other stripping mediums are used such as argon, helium, carbon dioxide, and mixtures thereof.

The fiber coating stripping apparatus 10 illustrated in FIG. 1 further includes a stripper exhaust 26 for receiving the removed outer coating 14′ shown as small droplets or particles in FIG. 1 in the manner described in further detail below. The stripper exhaust 26 is better illustrated in FIG. 2 which shows the illustrated embodiment of the stripper exhaust 26 as having an exhaust opening 28 positioned proximate to the nozzle 18 of FIG. 1 such that the optical fiber 12 is positioned substantially between the fiber stripper 16 and the exhaust opening 28 of the stripper exhaust 26. As can also be seen, the stripper exhaust 28 also includes a liquid injection mechanism 30 also discussed in further detail below that provides a liquid 32 to interior of the stripper exhaust 28. In the present illustrated embodiment, the liquid 32 is supplied to the stripper exhaust 26 via a supply tube 29 shown in FIG. 1.

Referring again to FIG. 1, a vacuum generator 36 is fluidically connected to the stripper exhaust 26 via tubing 38. The vacuum generator 36 creates an airflow through the exhaust opening 28 of the stripper exhaust 26 to vacuum the removed outer coating 14′ of the optical fiber 12 and to vacuum the liquid 32 provided by the liquid injection mechanism 30. In this regard, the vacuum generator 36 in the illustrated embodiment utilizes compressed air supplied by tubing 37 to generate vacuum in a manner described in further detail below. Moreover, the fiber coating stripping apparatus 10 of the illustrated embodiment in FIG. 1 is also provided with a holding tank 40 which is connected to the vacuum generator 36 via tubing 39. The holding tank 40 is adapted to receive the outer coating 14′ of the optical fiber 12 removed by the fiber stripper 16 and vacuumed through the stripper exhaust 26.

In accordance with the present embodiment, the liquid 32 is a coolant that cools the removed outer coating 14′ of the optical fiber 12 as the removed outer coating 14′ is vacuumed through the exhaust opening 28 by the vacuum generator 36. In this regard, the liquid 32 is water in the present embodiment since it is economical and provides sufficient cooling to the removed outer coating 14′. Of course, other liquids may be used in accordance with other embodiments of the present invention as well and the present invention is not limited to the type of liquid used. Because the removed outer coating 14′ is cooled from its melted state to a solid state, there is less likelihood that the removed outer coating 14′ will adhere to the interior wall of the stripper exhaust 26, the interior of the tubing 38, and the interior of the vacuum generator 36. This in turn reduces maintenance and cleaning requirements of these components.

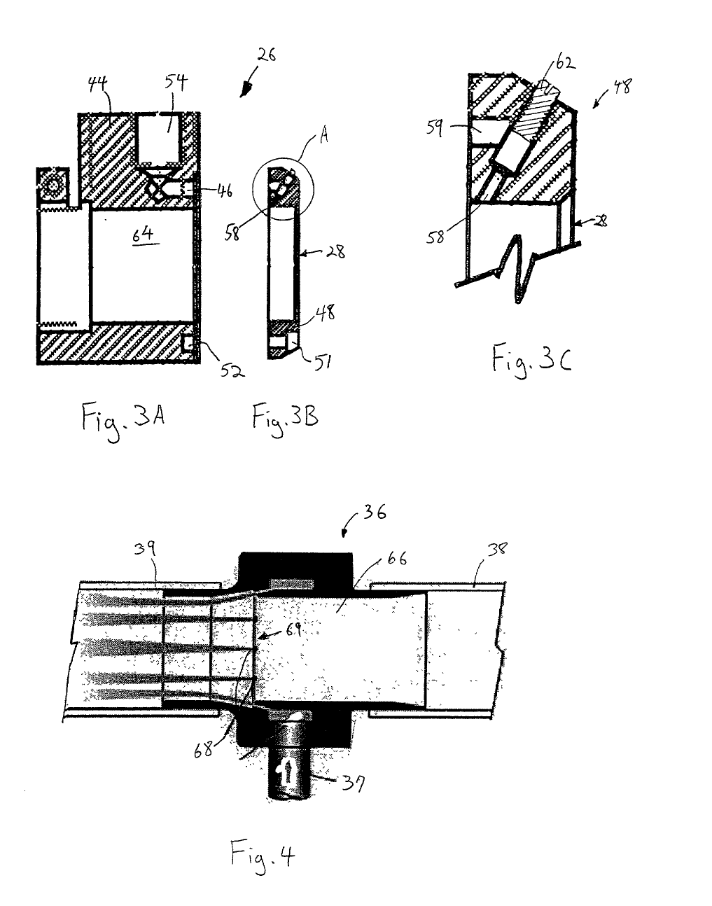

In this regard, a cross-sectional disassembled view of one preferred embodiment of the stripper exhaust 26 is shown in FIGS. 3A-3C. As can be seen in these figures as well as in FIG. 2, the stripper exhaust 26 in accordance with the present embodiment includes a housing 44 with a distribution groove 46 and a distribution ring 48. The distribution ring 48 is adapted to be securely mounted to the housing 44 using fasteners 50 which pass through the openings 51 of the distribution ring 48 and engage the housing 44 via threaded holes 52. The distribution ring 48 is provided with a plurality of spray openings 58 and is mounted to the housing 44 in a manner that the distribution groove 46 provides the liquid 32 supplied via the supply tube 29 and plenum 54 to the plurality of spray openings 58.

An enlarged cross-sectional view of a spray opening 58 marked “A” on the distribution ring 48 of FIG. 3B is shown in FIG. 3C. As can be appreciated, the spray opening 58 receives the liquid 32 through the passage 59 and directs the liquid 32 toward the opening 28 of the stripper exhaust 26. As can also be clearly seen in FIGS. 2 and 3C, an adjustment screw 62 is also provided for each of the plurality of spray openings 58 to allow adjustment of the flow rate of liquid 32 through the corresponding spray opening 58. As can be appreciated, by turning the adjustment screw 62 in a clockwise direction, the flow rate is further restricted whereas by turning the adjustment screw 62 in a counter-clockwise direction, the flow rate of the liquid 32 can be increased. In this manner, each of the plurality of spray openings 58 can be adjusted to ensure appropriate amount of liquid 32 is provided to cool the removed outer coating 14′ as it is vacuumed through the stripper exhaust 26.

In addition, as can also be seen in FIG. 2, the liquid 32 is provided very close to the exhaust opening 28 via the plurality of spray openings 58. This aids in ensuring that the outer coating 14′ is sufficiently cooled so that the removed outer coating 14′ does not adhere to the interior wall 64 of the stripper exhaust 26, the interior of the tubing 38, or the interior of the vacuum generator 36 as the outer coating 14′ is vacuumed through the exhaust opening 28. Moreover, in the illustrated embodiment, the liquid 32 is provided to the interior wall 64 of the stripper exhaust 26 so that the liquid 32 rinses the interior wall 64 as the liquid 32 is vacuumed by the vacuum generator 36. By rinsing the interior of the stripper exhaust 26, further reduction in maintenance requirements is realized since any cooled particles of the removed outer coating 14′ that may otherwise be stuck to the interior wall 64 is rinsed off. This rinsing feature of the present embodiment thus minimizes the potential for clogging the components of the fiber coating stripping apparatus 10 including the vacuum generator 36. As previously noted, whereas the liquid 32 in accordance with the illustrated embodiment is water, other liquids are used in other embodiments. Thus, by providing such a liquid, the fiber coating stripping apparatus 10 in accordance with the illustrated embodiment is, to a certain extent, self-cleaning so that maintenance and cleaning requirements is reduced thereby allowing increased productivity and reduced costs.

Of course, it should also be appreciated that in other embodiments of the present invention, the plurality of spray openings are provided directly along the interior wall of the stripper exhaust instead of being provided on a distribution ring as described above. Such an embodiment would work as effectively as the above described embodiment of the present invention in cooling the removed outer coating and rinsing the interior wall of the stripper exhaust. However, by providing the plurality of spray openings on a distribution ring as described, manufacturing of the stripper exhaust is greatly facilitated thereby reducing the manufacturing costs associated with the stripper exhaust.

FIG. 4 shows a cross-sectional view of the vacuum generator 36 of the fiber coating stripping apparatus 10 in accordance with one embodiment of the present invention. As can be seen, in the present embodiment, the vacuum generator 36 includes a venturi 66 and a plurality of jets 68 that provide compressed air from the inlet hose 37 to the venturi 66 to generate vacuum for vacuuming the removed outer coating 14′ of the optical fiber 12 and the liquid 32 provided in the stripper exhaust 26 as discussed above. It should be noted that the illustrated embodiment of the vacuum generator 36 is especially advantageous in that, as can be seen, it does not unduly impede the airflow and does not have components which obstruct the vacuuming of the removed outer coating 14′. This flow through design further minimizes the likelihood that the vacuum generator 36 will become clogged and ensures that the interior of the vacuum generator 36 will be rinsed by the liquid 32. In addition, the use of such a vacuum generator 36 also provides advantages not possible with other vacuum generators in that the compressed air from the inlet hose 37 and to add additional air to further cool the removed outer covering 14′. The vacuum generator 36 as described above is commercially available from Exair Corporation of 1250 Century Circle North, Cincinnati, Ohio 45246 of U.S.A. in their LineVac® line of products. Of course, it should also be appreciated that the above described vacuum generator 36 is merely one example of a vacuum generator which is appropriate for use in the fiber coating stripping apparatus 10 in accordance with the present invention and other vacuum generators can be used.

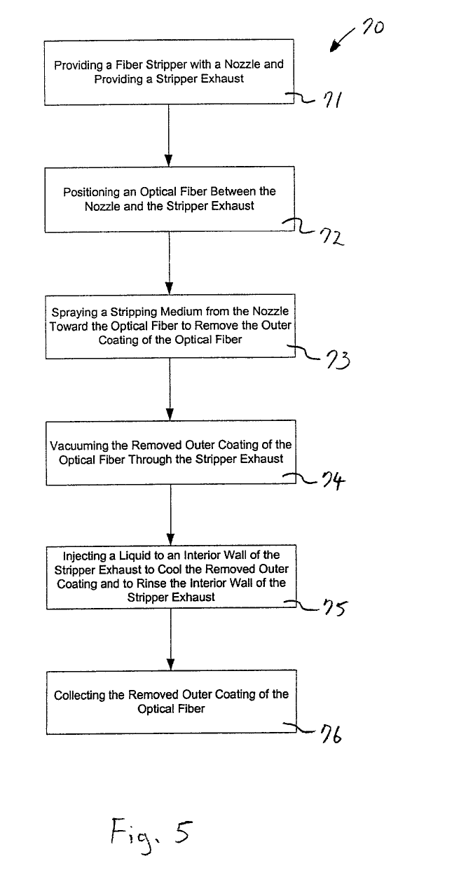

Thus, in view of the above discussion, it should be evident that the present invention also provides a method of stripping an outer coating of an optical fiber. FIG. 5 is a flow diagram illustrating a method 70 of stripping an outer coating of an optical fiber in accordance with one embodiment of the present invention. In accordance with the illustrated method 70, a fiber stripper with a nozzle and a stripper exhaust is provided in step 71. An optical fiber is positioned between the nozzle and the stripper exhaust in step 72. In step 73, a stripping medium is sprayed from the nozzle toward the optical fiber to remove the outer coating of the optical fiber. The removed outer coating of the optical fiber is vacuumed through the stripper exhaust in step 74. As the removed outer coating is being vacuumed through the stripper exhaust, a liquid is injected to an interior wall of the stripper exhaust in step 75 to cool the removed outer coating and to rinse the interior wall of the stripper exhaust. The removed outer coating is then collected in step 76. In another embodiment, the step of injecting the liquid is attained by a liquid injection mechanism. In still another embodiment, the present method further includes the step of adding compressed air to generate the vacuum and to add additional air to further cool the removed outer coating.

In the above described manner, the present invention provides a stripping apparatus and method of stripping an outer coating of an optical fiber which reduces maintenance requirements to reduce downtime and increase productivity. As evident from the discussion above, the present invention keeps the stripping apparatus clean and cools the removed outer coating of the optical fiber for disposal. While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. A fiber coating stripping apparatus for removing an outer coating of an optical fiber comprising:
a fiber stripper with a nozzle adapted to spray a stripping medium toward an outer surface of the optical fiber to remove the outer coating provided on the optical fiber;
a stripper exhaust with an exhaust opening positioned proximate to the nozzle such that the optical fiber is positioned substantially between the fiber stripper and the exhaust opening, the stripper exhaust including a liquid injection mechanism that provides a liquid to an interior of the stripper exhaust; and
a vacuum generator fluidically connected to the stripper exhaust that creates an airflow through the exhaust opening to vacuum the removed outer coating of the optical fiber and to vacuum the liquid provided by the liquid injection mechanism.

2. The fiber coating stripping apparatus of claim 1, wherein the liquid is a coolant that cools the removed outer coating of the optical fiber as the removed outer coating is vacuumed by the vacuum generator.

3. The fiber coating stripping apparatus of claim 1, wherein the liquid rinses the interior of the stripper exhaust as the liquid is vacuumed by the vacuum generator.

4. The fiber coating stripping apparatus of claim 1, wherein the liquid provided by the liquid injection mechanism is water.

5. The fiber coating stripping apparatus of claim 1, wherein the liquid injection mechanism includes a plurality of spray openings positioned along an interior wall of the stripper exhaust.

6. The fiber coating stripping apparatus of claim 1, wherein the liquid injection mechanism includes a distribution ring to distribute the liquid.

7. The fiber coating stripping apparatus of claim 6, wherein the distribution ring includes a plurality of spray openings for providing the liquid to the interior of the stripper exhaust.

8. The fiber coating stripping apparatus of claim 7, wherein the liquid is a coolant that cools the removed outer coating of the optical fiber as the removed outer coating is vacuumed by the vacuum generator, and rinses the interior wall of the stripper exhaust as the liquid is vacuumed by the vacuum generator.

9. The fiber coating stripping apparatus of claim 1, wherein the vacuum generator includes a venturi and a plurality of jets for providing compressed air to the venturi to generate vacuum and to further cool the removed outer covering.

10. The fiber coating stripping apparatus of claim 1, further comprising a holding tank that receives the outer coating of the optical fiber removed by the fiber stripper and vacuumed though the stripper exhaust.

11. A method of stripping the protective coating of an optical fiber comprising the steps of:
providing a fiber stripper with a nozzle;
spraying a stripping medium from the nozzle toward the optical fiber to remove the protective coating;
vacuuming the removed protective coating; and
injecting a liquid to cool the removed protective coating as the removed protective coating is vacuumed.

12. The method of claim 11, wherein the step of vacuuming the removed outer coating is attained by generating a suction airflow through a stripper exhaust.

13. The method of claim 12, wherein the liquid is injected onto an interior wall of the stripper exhaust.

14. The method of claim 13, further including the step of rinsing the interior wall of the stripper exhaust with the injected liquid.

15. The method of claim 11, wherein the step of injecting the liquid is attained by a liquid injection mechanism.

16. The method of claim 15, wherein the liquid injection mechanism includes a plurality of spray openings positioned along the interior wall of the stripper exhaust.

17. The method of claim 15, wherein the liquid injection mechanism includes a distribution ring to distribute the liquid.

18. The method of claim 11, further including the step of adding compressed air to generate the vacuum and to add additional air to further cool the removed outer coating.

19. The method of claim 11, further including the step of collecting the removed outer coating of the optical fiber removed by the fiber stripper.

20. The method of claim 11, wherein the liquid is water.
